(19) United States
(12) Patent Application Publication
(10) Pub. No.: US 2007/0168994 A1
(43) Pub. Date: Jul. 19, 2007

(54) Debugging a computer program in a distributed debugger

(75) Inventors: Eric L. Barsness, Pine Island, MN (US); John M. Santosuosso, Rochester, MN (US)

Correspondence Address: IBM (ROC-BLF), C/O BIGGERS & OHANIAN, LLP, P.O. BOX 1469, AUSTIN, TX, 78767-1469, US

(73) Assignee: INTERNATIONAL BUSINESS MACHINES CORPORATION, ARMONK, NY (US)

(21) Appl. No.: 11/266,735

(22) Filed: Nov. 3, 2005

(51) Int. Cl. G06F 9/44

(52) U.S. Cl. 717/129

(57) ABSTRACT

Methods, apparatus, and computer program products are disclosed for debugging a computer program in a distributed debugger that include defining a conditional breakpoint conditioned upon one or more attributes of a remote execution environment, debugging the computer program in a debug session in the remote execution environment, and retrieving debug information at the breakpoint conditioned upon one or more attributes of the remote execution environment.

### BACKGROUND OF THE INVENTION

1. Field of the Invention

The field of the invention is data processing, or, more specifically, methods, systems, and products for debugging a computer program in a distributed debugger.

2. Description of Related Art

The development of the EDVAC computer system of 1948 is often cited as the beginning of the computer era. Since that time, computer systems have evolved into extremely complicated devices. Today's computers are much more sophisticated than early systems such as the EDVAC. Computer systems typically include a combination of hardware and software components, application programs, operating systems, processors, buses, memory, input/output devices, and so on. As advances in semiconductor processing and computer architecture push the performance of the computer higher and higher, more sophisticated computer software has evolved to take advantage of the higher performance of the hardware, resulting in computer systems today that are much more powerful than just a few years ago.

As computer software has become more sophisticated, computer programs called ‘debuggers’ that are used to analyze software defects or to optimize performance have also evolved. A debugger allows a user to follow the flow of program execution and inspect the state of a program at any point by controlling execution of the program being debugged. A debugger typically allows a user to track program variables, run a program step by step, stop program execution at a particular line number in computer program code, or stop program execution when certain conditions are satisfied.

Some debuggers offer users a more sophisticated feature called distributed debugging. A distributed debugger provides the ability to debug a computer program running on one computer system from another computer system. When using a distributed debugger, computer program code that is being debugged typically may be run on a number of different computer systems each of which may have a different configuration of computer resources. The variety of configurations and resources available increases the difficulty of debugging a computer program. A computer program may run well on a NetBSD operating system, for example, while consistently producing errors when run on a Linux™ operating system. A program may run well on one version of a processor and generate errors when run on a slightly later version of the same processor. A program may run well on a node of a grid environment and generate errors when run on another node of the same grid environment.

Reproducing in a test lab program errors generated across multiple remote execution environments to try to debug the computer program is not generally feasible. In order to reproduce the execution environment for debugging the computer program, a user would need to recreate every type execution environment in which the computer program might run, and a user often cannot anticipate the types of execution environment in which the computer program will run. In addition, even if a test lab could duplicate all the platforms, operating systems, and execution environments generally in which a program being debugged might ever be run, there would still be no way in the current state of the art for a tester to detect errors based upon attributes of the various execution environments.

### SUMMARY OF THE INVENTION

Methods, apparatus, and computer program products are disclosed for debugging a computer program in a distributed debugger that include defining a conditional breakpoint conditioned upon one or more attributes of a remote execution environment, debugging the computer program in a debug session in the remote execution environment, and retrieving debug information at the breakpoint conditioned upon one or more attributes of the remote execution environment.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a network diagram illustrating an exemplary system for debugging a computer program in a distributed debugger according to embodiments of the present invention.

FIG. 2 sets forth a block diagram of an exemplary system for debugging a computer program in a distributed debugger according to embodiments of the present invention.

FIG. 3 sets forth a block diagram of automated computing machinery comprising an exemplary computer useful in debugging a computer program in a distributed debugger according to embodiments of the present invention.

FIG. 4 sets forth a line drawing of an exemplary debugger client GUI of a distributed debugger for debugging a computer program in a distributed debugger according to embodiments of the present invention.

FIG. 5 sets forth a flow chart illustrating an exemplary method for debugging a computer program in a distributed debugger according to embodiments of the present invention.

FIG. 6 sets forth a line drawing of an exemplary data structure that supports debugging a computer program in a distributed debugger according to embodiments of the present invention.

### DETAILED DESCRIPTION OF EXEMPLARY EMBODIMENTS

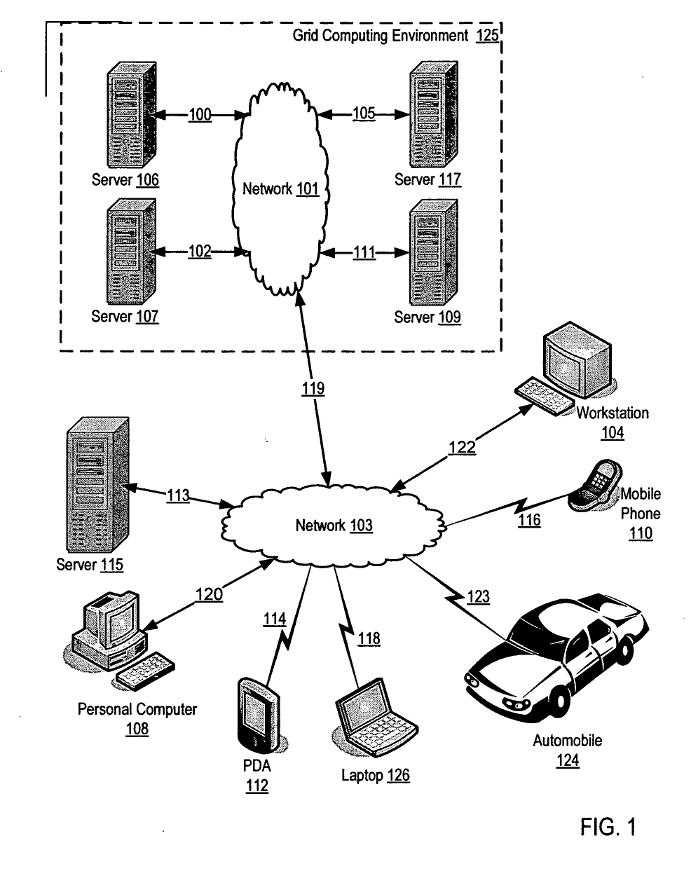

Exemplary methods, systems, and products for debugging a computer program in a distributed debugger according to embodiments of the present invention are described with reference to the accompanying drawings, beginning with FIG. 1. FIG. 1 sets forth a network diagram illustrating an exemplary system for debugging a computer program in a distributed debugger according to embodiments of the present invention. The system of FIG. 1 operates generally to carry out debugging a computer program in a distributed debugger according to embodiments of the present invention by defining a conditional breakpoint conditioned upon one or more attributes of a remote execution environment, debugging a program in a debug session in a remote execution environment, and retrieving debug information at the conditional breakpoint conditioned upon one or more attributes of a remote execution environment.

A distributed debugger is a client/server application that allows for analyzing software defects or optimizing performance of a computer program running on one computer system while controlling the debugging session from another computer system. A distributed debugger assists in the analysis of software defects and optimization of performance by controlling the execution of a computer program by a computer processor. Examples of distributed debuggers that may be improved to operate according to embodiments of the present invention include the IBM Distributed Debugger, Allinea Software's Distributed Debugging Tool, Lynux Works™ TotalView, or any other distributed debugger as will occur to those of skill in the art.

A debugger server is a computer program that controls the execution of a computer program by a computer processor according to communications from a debugger client. A debugger server runs on the same computer system as a computer program under debug. In this specification, a debugger server is sometimes referred to as a ‘debugger engine.’

A debugger client is a computer program that provides a user interface for operating a debug engine. A debugger client may, for example, provide a user interface for operating a debug engine to set breakpoints, to step through computer program code, and to examine the content of variables. A debugger client may allow for simultaneous debugging of multiple computer programs using multiple debug sessions. A debug session is implemented through a connection between a debugger client and one or more debugger engines involving an exchange of data during the establishment, maintenance, and release of the connection for distributed debugging of a computer program.

A remote execution environment is one or more computer systems, each computer system capable of running a debugger engine of a distributed debugger to control the execution of a computer program. Debugger engines of a remote execution environment operate according to requests of a debugger client. The debugger client typically is located remotely across a network from a remote execution environment, and this is the sense in which the remote execution environment is ‘remote.’ A remote execution environment may be implemented, for example, as a single computer server running a debugger engine connected remotely to a debugger client, as several servers managed as a cluster server with each server running a debugger engine connected remotely to a debugger client, as a grid computing environment with one or more nodes of the grid running debugger engines connected remotely to a debugger client, and in other architectures as will occur to those of skill in the art.

The system of FIG. 1 includes servers (106, 107, 109, and 117) which are connected to network (101) through wireline connections (100, 102, 105, 111). Servers (106, 107, 109, and 117) implement a grid computing environment (125) with data communications provided through network (101). A grid computing environment is a group of computer systems that deliver the power of multiple systems' resources to a single user point for a specific user purpose. The Global Grid Forum (‘GGF’) is the principal standards organization for grid computing. GGF is a collaboration between industry and academia with significant support from both. Grid computing provisions a computational task with administratively distant computer resources. The focus of grid technology is associated with the issues and requirements of flexible computational provisioning beyond the local (home) administrative domain, that is, in remote execution environments. A grid computing environment appears to a user as a single virtual computing system. A grid computing environment coordinates and provides to a user computational, application, data, storage, or network resources. Such resources are scalable, dynamic, and geographically dispersed among heterogeneous computer systems.

A breakpoint is a special instruction inserted into executable computer machine code of a computer program that stops execution of the computer machine code by a processor and returns processor control through an operating system to a debugger engine. Special instructions used as breakpoints are defined by a computer processor's architecture and may include, for example, an illegal opcode or a dedicated breakpoint instruction inserted into the computer machine code of a computer program.

A debugger engine may insert a breakpoint directly into computer machine code to carry out the debugger engine's own program operations. A breakpoint inserted directly into computer machine code to carry out the debugger engine's own program operations is referred to in this specification as an ‘internal breakpoint.’ For example, a debugger engine may insert an internal breakpoint directly after a line of computer program code to carry out execution of a single line of computer program code. Internal breakpoints inserted by a debugger engine to carry out the debugger engine's own program operations generally are not visible to a user of a distributed debugger through a debugger client.

In addition to internal breakpoints inserted by a debugger engine to carry out the debugger engine's own program operations, a user may insert a breakpoint into computer program code through the user interface of a debugger client. A breakpoint inserted by a user through a user interface of a debugger client is referred to in this specification as a ‘user breakpoint.’ The purpose of a user breakpoint is to return control of a debugger's user interface to a user so that the user can view contents of registers, memory variables, and the like, at particular points in program execution of a program being debugged. The effects of user breakpoints therefore generally are visible to the user.

A conditional breakpoint is a type of user breakpoint that causes a debugger engine to notify a user of the user breakpoint encounter through a debugger client in dependence upon an evaluation of an associated condition. Conditions are expressions that are evaluated by a distributed debugger when a conditional breakpoint causes processor control to return to the debugger engine. Conditional breakpoints, for example, may cause a debugger engine to pause execution of a program being debugged and notify a user of the conditional breakpoint encounter when, for example:
a register contains a certain value and the remote execution environment of the program being debugged includes the Linux™ operating system,
a memory variable contains a certain value and the remote execution environment of the program being debugged includes a Pentium M™ processor, or
a register contains a certain value, a memory variable contains a certain value, and the remote execution environment of the program being debugged includes a certain grid node identification code.

Computer machine code is a system of numeric codes directly executable by a computer processor. A computer machine code may, for example, instruct a computer processor to store the sum of a first register and a second register into the first register. Computer machine code is computer processor dependent, and computer machine codes therefore vary from one computer processor to another. Computer machine code is typically generated from computer program code. Computer program code is a series of statements written in some human-readable computer programming language such as, for example, Java, C++, Visual Basic, SQL, Fortran, or assembly language. Computer program code is typically organized in lines, each line containing one or more statements. Computer program code is converted into computer machine code either by a compiler for a particular computer processor, by an assembler for an assembly language for a particular computer processor, or on the fly from a human-readable form with the aid of an interpreter. In this specification, both a computer machine code and a computer program code, alone or in combination, are referred to as a ‘computer program instruction.’

The system of FIG. 1 also includes the following devices:
server (115) coupled for data communications to network (103) through wireline connection (113),
personal computer (108) coupled for data communications to network (103) through wireline connection (120),
personal digital assistant (‘PDA’) (112) coupled for data communications to network (103) through wireless connection (114),
laptop (126) coupled for data communications to network (103) through wireless connection (118),
automobile (124) coupled for data communications to network (103) through wireless connection (123),
network-enabled mobile phone (110) coupled for data communications to network (103) through wireless connection (116), and
computer workstation (104) coupled for data communications to network (103) through wireline connection (122)

Each device in the system of FIG. 1 may support a distributed debugger with a debugger engine operating in a remote execution environment with respect to a debugger client. In addition, each device in the system of FIG. 1 may support a debugger client of a distributed debugger, although some of the devices may be less preferred as clients. Automobile (124), for example, possibly may not contain a generally programmable client computer, so that automobile (124) as a practical matter may not conveniently support a debugger client, although embedded system in automobile (124) such as a fuel injection controller or a timing sequence controller for example, may usefully support a debugger engine of a distributed debugger. PDA (112) and mobile phone (110) may have display screens that may be too small to support the GUI demands of some debugger clients, although PDA (112) and mobile phone (110) may usefully support a debugger engine of a distributed debugger.

The system of FIG. 1 does, however, support distributed debugging in many ways with a debugger client debugging a program through a debugger engine in a remote execution environment. A distributed debugger may be implemented, for example, with a debugger client on personal computer (108) debugging a program through a debugger engine in a remote execution environment on workstation (104). A distributed debugger may be implemented with a debugger client on laptop (126) debugging a program through a debugger engine in a remote execution environment on server (115). A distributed debugger may be implemented with a debugger client on workstation (104) debugging a program through debugger engines in a remote execution environment in grid (125). And in an exemplary system like the one illustrated in FIG. 1, a distributed debugger may be implemented with a debugger client debugging a program through a debugger engine in a remote execution environment in other ways as will occur to those of skill in the art.

In the system of FIG. 1, network (101) and network (103) interconnect through network connection (119), forming a larger wide area network or ‘WAN.’ Network (101) may be a local area network (‘LAN’) such as, for example, an enterprise LAN supporting an enterprise grid computing environment. Or network (101) may be a WAN such as, for example, the Internet, providing grid computing resources as publicly available Web Services exposed to the World Wide Web through a UDDI (Universal Description Discover and Integration) registry such as, for example, the IBM UDDI Business Registry. Network (103) may be an enterprise LAN coupled to network (101) through a router, a gateway, or a firewall. Or networks (101, 103) may both be subnets of an internet coupled through routers. Such networks are media used to provide data communications connections between various devices and computers connected together within an overall data processing system. The network connection aspects of the architecture of FIG. 1 are only for explanation, however, not for limitation of the present invention. In fact, systems for debugging a computer program in a distributed debugger may be connected as LANs, WANs, intranets, internets, the Internet, webs, the World Wide Web itself, or other connections as will occur to those of skill in the art.

The arrangement of servers and other devices making up the exemplary system illustrated in FIG. 1 are for explanation, not for limitation. Data processing systems useful according to various embodiments of the present invention may include additional servers, routers, other devices, and peer-to-peer architectures, not shown in FIG. 1, as will occur to those of skill in the art. Networks in such data processing systems may support many data communications protocols, including for example TCP (Transmission Control Protocol), IP (Internet Protocol), HTTP (HyperText Transfer Protocol), WAP (Wireless Access Protocol), HDTP (Handheld Device Transport Protocol), and others as will occur to those of skill in the art. Various embodiments of the present invention may be implemented on a variety of hardware platforms in addition to those illustrated in FIG. 1.

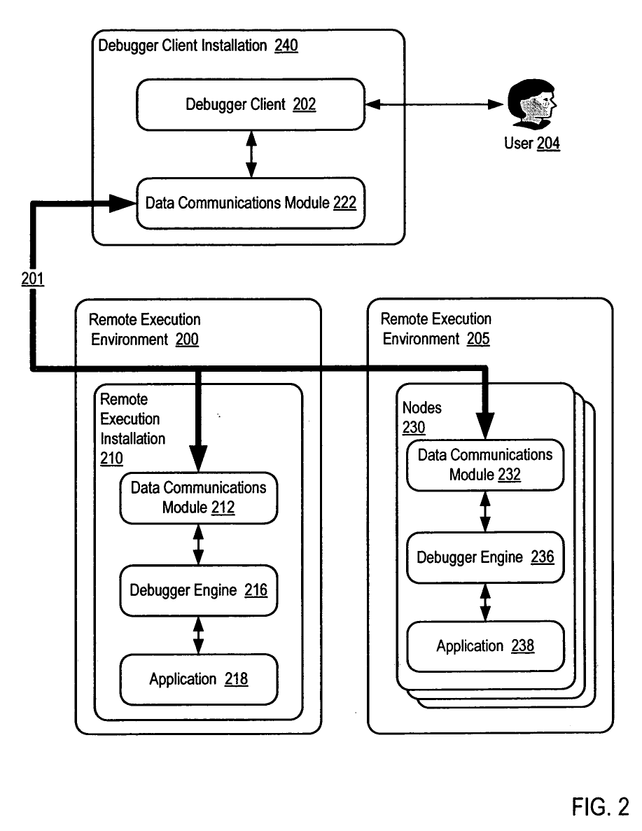

For further explanation, FIG. 2 sets forth a block diagram of an exemplary system for debugging a computer program in a distributed debugger according to embodiments of the present invention. The block diagram of FIG. 2 includes a debugger client installation (240). Debugger client installation (240) is a computer system that contains a debugger client (202) and a data communications module (222). In the example of FIG. 2, debugger client installation (240) may be implemented as a computer workstation connected to the Internet, the computer workstation having a display screen, a keyboard, and a mouse.

In the block diagram of FIG. 2, debugger client (202) is a set of computer program instructions that provide a user interface for a user (204) to operate debug engines (216 and 236). User (204) may operate a debugger client (202), for example, by operating a keyboard or operating buttons of a graphical user interface. Debugger client (202) communicates with debugger engines (216 and 236) through data communications module (222), and the debugger client (202) communicates with data communications module (222) through function calls of a data communications API provided by a data communications module (222).

In the block diagram of FIG. 2, data communications module (222) is a set of computer program instructions that provides debugger client (202) one end of a data communications connection through a data communications API. In TCP parlance, the endpoint of a data communications connection is a data structure called a ‘socket.’ Two sockets form a data communications connection, and each socket includes a port number and a network address for the respective data connection endpoint. Through a data communications connection (201) with data communications modules (212 and 232), data communications module (222) provides debugger client (202) the ability to communicate with debugger engines (216 and 236) without regard for how the data travels through network connection (201). Data communications connection (201) may be implemented using data communications protocols such as, for example, TCP and IP.

The block diagram of FIG. 2 includes a remote execution environment (200). Remote execution environment (200) is a computing environment in which debugger engine (216) of a distributed debugger controls the execution of application (218). In the example of FIG. 2, remote execution environment (200) is implemented as a remote execution environment having no graphical user interface such as, for example, an IBM eServer® iSeries™ or an IBM eServer® zSeries™.

In the block diagram of FIG. 2, remote execution environment (200) includes a remote execution installation (210). Remote execution installation (210) is a computer system that contains a data communications module (212), a debugger engine (216), and application (218). In the example of FIG. 2, remote execution installation (210) may be implemented, for example, as a single computer server connected to the Internet.

The block diagram of FIG. 2 includes a remote execution environment (205). In the example of FIG. 2, remote execution environment (205) is implemented as a grid computing environment. The grid computing environment of FIG. 2 is represented by network-connected nodes (230). Each node has installed upon it a data communications module (232), a debugger engine (236), and an application (238) for execution and debugging in a grid computing environment.

In the block diagram of FIG. 2, data communications module (232) is a set of computer program instructions that provides debugger engine (236) one end of a data communications connection through a data communications API. The data communications endpoint may be implemented, for example, as a TCP socket. Through data communications connection (201) with data communications module (222), data communications module (232) provides debugger engine (236) the ability to communicate with debugger client (202).

In the block diagram of FIG. 2, debugger engine (236) controls execution of application (238) through a debug API of an operating system according to communications with debugger client (202). Debugger engine (236) communicates with debugger client (202) through data communications module (232). Debugger engine (236) communicates with data communications module (232) by invoking function calls of a data communications API provided by data communications module (232).

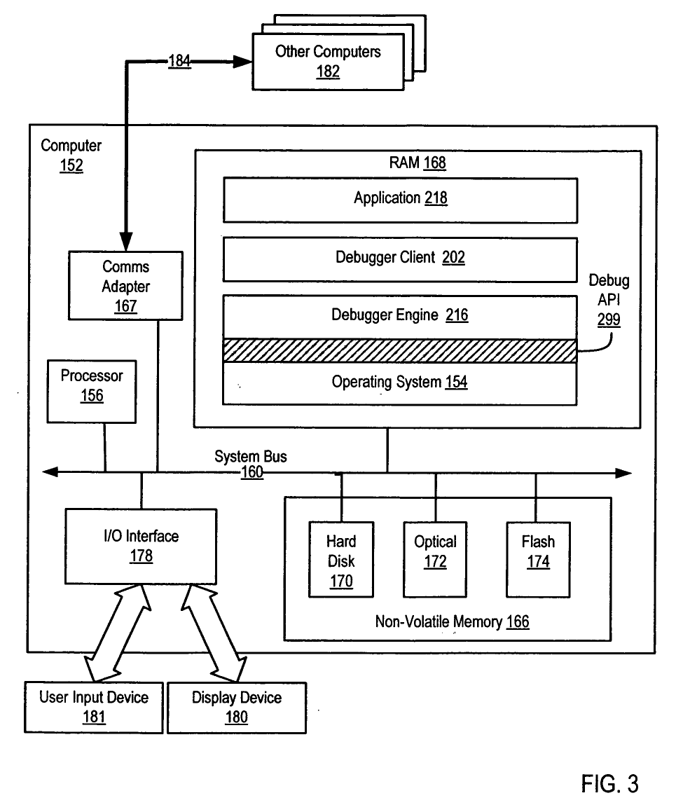

Debugging a computer program in a distributed debugger in accordance with the present invention is generally implemented with computers, that is, with automated computing machinery. In the system of FIG. 1, for example, all the nodes, servers, and communications devices are implemented to some extent at least as computers. For further explanation, therefore, FIG. 3 sets forth a block diagram of automated computing machinery comprising an exemplary computer (152) useful in debugging a computer program in a distributed debugger according to embodiments of the present invention. Computer (152) includes at least one computer processor (156) or ‘CPU’ as well as random access memory (168) (‘RAM’) which is connected through a system bus (160) to processor (156) and to other components of the computer.

Processor (156) provides features useful in debugging a computer program in a distributed debugger. Features of processor (156) useful in debugging may include the ability to specify a breakpoint by providing a debugging opcode of the processor specifically for that purpose. Processor (156) may provide an ‘interrupt’ or ‘trap’ feature that vectors control flow to a debugger when the processor encounters a debugging opcode. A debugging opcode and a debugging interrupt provide processor (156) with the ability to notify an operating system that a debugging event has occurred with respect to a process or thread running on the processor; the operating system then may notify a debugger of the debugging event by, for example, vectoring the interrupt to a debugging module in computer memory. In addition, a computer processor provides the ability to read and write directly out of and into the computer processor registers when a debugging interrupt occurs.

Stored in RAM (168) is an operating system (154). An operating system is the computer program responsible for the direct control and management of computer hardware and of basic computer system operations. Operating system (154) provides hardware and system control and management to a debugger through a debug application programming interface (‘API’) (299). Debug API (299) is a set of functions or software routines provided by operating system (154) for use by a debugger engine. Examples of the kinds of functions that may be included in debug API (299) include functions that enable a debugger to read values from and set values in memory, read and set values in processor registers, suspend and resume thread processing, and so on. Operating systems useful in computers according to embodiments of the present invention include UNIX™, Linux™, Microsoft NT™, AIX™, IBM's i5/OS™, and others as will occur to those of skill in the art.

Also stored in RAM (168) is a debugger client (202) and debugger engine (216). Debugger client (202) is a set of computer program instructions for providing a user interface and sending requests to a debug engine for use in controlling the execution of a computer program. Debugger engine (216) is a set of computer program instructions improved for debugging a computer program in a distributed debugger according to embodiments of the present invention. Debugger engine (216) is improved according to embodiments of the present invention for defining a conditional breakpoint conditioned upon one or more attributes of a remote execution environment, debugging a program in a debug session in a remote execution environment, and retrieving debug information at the conditional breakpoint conditioned upon one or more attributes of a remote execution environment.

Also stored in RAM (168) is an application (218), a computer software program for carrying out user-level data processing. In the example of FIG. 3, debugger engine (216) and debugger client (202) provide distributed debugging of application (218). Though debugger engine (216) and debugger client (202) for ease of explanation are both depicted in the same computer (152) in the example of FIG. 3, readers will recognize that debugger engine (216) and debugger client (202) typically are installed on different computer systems. Application (218), debugger client (202), debugger engine (216), and operating system (154) in the example of FIG. 3 are shown in RAM (168), but many components of such software typically are stored in non-volatile memory (166) also.

Computer (152) of FIG. 3 includes non-volatile computer memory (166) coupled through a system bus (160) to processor (156) and to other components of the computer (152). Non-volatile computer memory (166) may be implemented as a hard disk drive (170), optical disk drive (172), electrically erasable programmable read-only memory space (so-called ‘EEPROM’ or ‘Flash’ memory) (174), RAM drives (not shown), or as any other kind of computer memory as will occur to those of skill in the art.

The example computer of FIG. 3 includes one or more input/output interface adapters (178). Input/output interface adapters in computers implement user-oriented input/output through, for example, software drivers and computer hardware for controlling output to display devices (180) such as computer display screens, as well as user input from user input devices (181) such as keyboards and mice.

The exemplary computer (152) of FIG. 3 includes a communications adapter (167) for implementing data communications (184) with other computers (182). Such data communications may be carried out serially through RS-232 connections, through external buses such as USB, through data communications networks such as IP networks, and in other ways as will occur to those of skill in the art. Communications adapters implement the hardware level of data communications through which one computer sends data communications to another computer, directly or through a network. Examples of communications adapters useful for determining availability of a destination according to embodiments of the present invention include modems for wired dial-up communications, Ethernet (IEEE 802.3) adapters for wired network communications, and 802.11b adapters for wireless network communications.

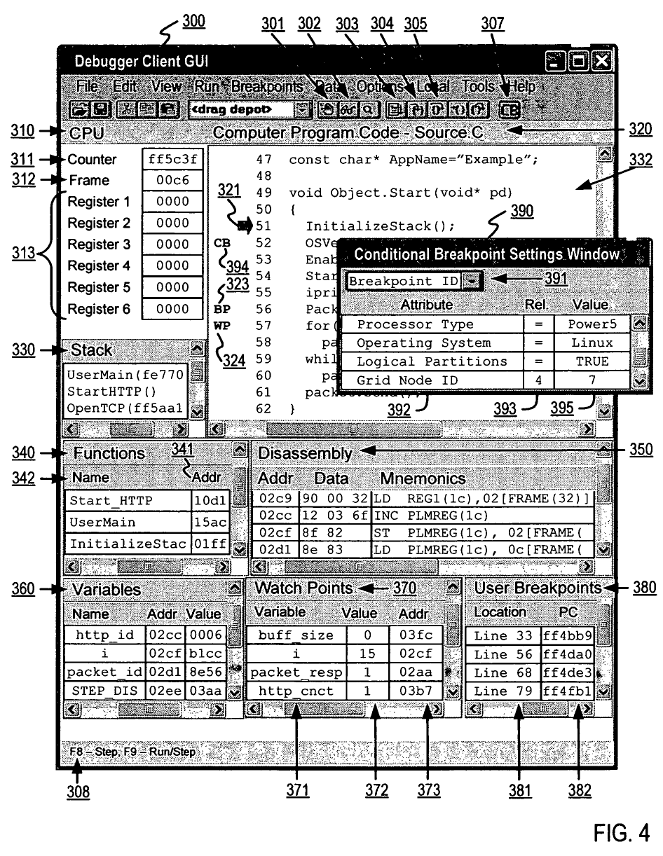

For further explanation, FIG. 4 sets forth a line drawing of an exemplary debugger client GUI (300) of a distributed debugger for debugging a computer program in a distributed debugger according to embodiments of the present invention. In the example of FIG. 4, debugger client GUI (300) displays a GUI step button (303) for operating a debugger step function. In addition to providing a GUI step button to operate a debugger step function, the user interface of FIG. 4 also provides a keyboard shortcut (308) for operating a debugger step function. Debugger client GUI (300) provides a text block (332) in which a debugger displays a segment of computer program instructions executing in a remote execution environment presently affected by distributed debugging operations. Each call to the debugger step function moves a step cursor (321) to the line of computer program code containing the next statement of computer program code for execution by a computer processor in a remote execution environment.

In the example of FIG. 4, debugger client GUI (300) displays a GUI step-in button (304) for operating a step-in function of a debugger. The step-in function causes control flow entry into a program control flow structure. Operating the step-in function while the step cursor (321) is located on a control flow entry point, such as, for example, line 51 of computer program code (320), moves the step cursor (321) to the line containing the first statement of computer program code inside the control flow structure entered.

In the example of FIG. 4, debugger client GUI (300) displays a GUI button (305) for operating a step-over function of a debugger to cause control flow entry over a program control flow structure. Operating the step-over function while the step cursor (321) is located on a control flow entry point, such as, for example, line 51 of computer program code (320), moves the step cursor (321) to the line containing the next statement of computer program code in the current control flow structure such as, for example, line 52 of computer program code (320).

In the example of FIG. 4, debugger client GUI (300) displays a GUI button (301) for inserting a user breakpoint into computer program code (300). A user breakpoint inserted into computer program code (300) is represented by a ‘BP’ (323) next to a line number of computer program code (300) and appears in a user breakpoints section (380) of debugger client GUI (300).

The user breakpoints section (380) of debugger client GUI (300) in the example of FIG. 4 displays a list of all user breakpoints in computer program code (320). The user breakpoints section (380) depicts data associating a user breakpoint location (381) in computer program code with a program counter value (382). Program counter value (382) is the value of a computer processor's program counter when the computer processor encounters the user breakpoint.

In the example of FIG. 4, debugger client GUI (300) displays a watch point icon (302) for inserting a watch point into computer program code (300). A watch point inserted into computer program code (300) is represented by a ‘WP’ (324) next to a line number of computer program code (300) and appears in a watch points section (370) of debugger client GUI (300).

The watch point (370) section of debugger client GUI (300) in the example of FIG. 4 displays a list of all watch points in computer program code (320). The watch point section (370) depicts data associating a watch point variable (371) to monitor for a particular value (372) with a computer memory location (373) containing the value (372) of the watch point variable (371).

In the example of FIG. 4, debugger client GUI (300) displays a conditional breakpoint icon (307) for inserting a conditional breakpoint into computer program code (300). A user operates GUI button (307) to display a conditional breakpoint settings window (390). A conditional breakpoint inserted into computer program code (300) is represented by a ‘CB’ (394) next to a line number of computer program code (300).

The conditional breakpoint settings window (390) is a GUI for prompting a user to enter conditions for a conditional breakpoint (391). In the example of FIG. 4, conditional breakpoint settings window (390) depicts data associating a breakpoint identifier (391) with an attribute (392) of a remote execution environment, a value (395), and a relationship (393) between the attribute (392) and the value (395).

In the example of FIG. 4, debugger client GUI (300) includes a functions section (340). The functions section (340) depicts data associating a function (342) with a computer memory location (341) for all functions in computer program code (306). Computer memory location (341) contains the location of the first computer program instruction of function (342) for execution.

In the example of FIG. 4, debugger client GUI (300) includes a CPU section (310) that depicts information regarding the state of a processor in a remote execution environment executing the computer machine code represented by computer program code (320). The CPU section (310) of debugger client GUI (300) displays the values contained in program counter (311), frame counter (312), registers (313), and stack (330). A program counter is a register in the CPU that points to a memory location for the next instruction to be executed by a processor. The value of the program counter changes after each instruction is executed, either by incrementing the program counter by the length of the previous instruction or due to a branch to a new memory location containing a new instruction. A stack is a run-time data structure that stores data last-in, first-out.

Debugger client GUI (300) in the example of FIG. 4 includes a disassembly section (350). The disassembly section (350) displays assembly language for computer machine code executing on a processor. The disassembly section (350) in the example of FIG. 4 depicts data associating computer machine code data, a memory address containing the data, and assembly language mnemonics of the data.

In the example of FIG. 4, debugger client GUI (300) includes a variables section (360). The variables section (360) contains a list of all variables in computer program code (320). The variable section (360) in the example of FIG. 4 depicts data associating a variable name, a current value, and a memory address for storing the value.

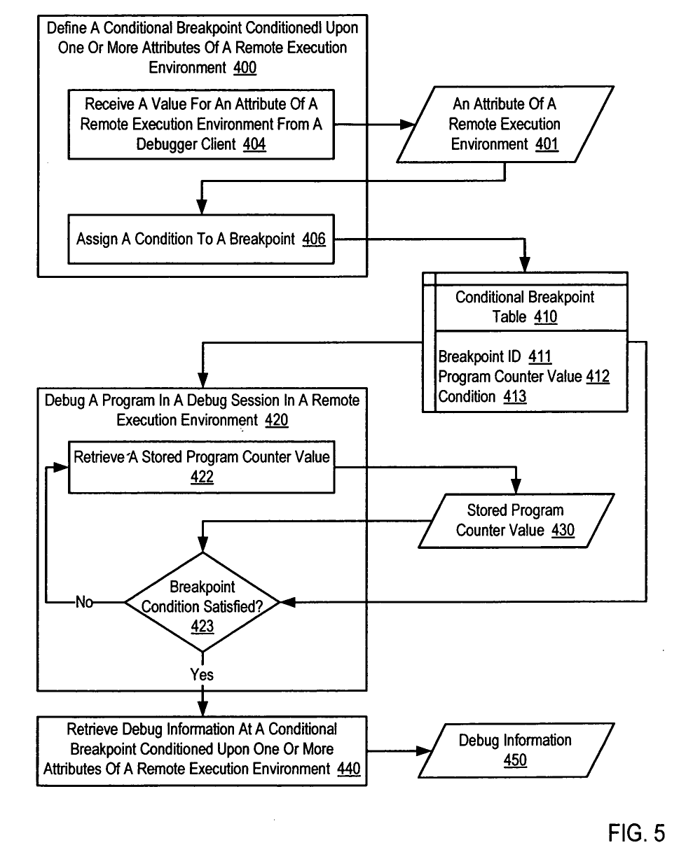

For further explanation, FIG. 5 sets forth a flow chart illustrating an exemplary method for debugging a computer program in a distributed debugger according to embodiments of the present invention that includes defining (400) a conditional breakpoint conditioned upon one or more attributes of a remote execution environment, debugging (420) a computer program in a debug session in the remote execution environment, and retrieving (440) debug information at a conditional breakpoint conditioned upon attributes of the remote execution environment.

Defining (400) a conditional breakpoint conditioned upon one or more attributes of a remote execution environment according to the method of FIG. 5 includes receiving (404) a value for an attribute (401) of a remote execution environment from a debugger client. Attributes (401) of a remote execution environment may include, for example, a type of operating system running in the remote execution environment or the physical location of the remote execution environment. A debugger engine may receive (404) a value for an attribute (401) of a remote execution environment from a debugger client through an endpoint of a data communications connection such as, for example, a TCP socket. The value of the attribute may be entered by a user through a GUI of the debugger client, for example, as part of the process of defining a conditional breakpoint.

In the method of FIG. 5, defining (400) a conditional breakpoint conditioned upon one or more attributes of a remote execution environment includes assigning (406) a condition (413) to a conditional breakpoint. The condition may be associated with the conditional breakpoint by use of a data structure such as conditional breakpoint table (410). Conditional breakpoint table (410) in the example of FIG. 5 associates a breakpoint identifier (411) with a program counter value (412) and a condition (413). Program counter value (412) is the value of a computer processor's program counter when the computer processor encounters the conditional breakpoint identified by breakpoint identifier (411). A condition (413) is a Boolean expression that a debugger engine evaluates when encountering a conditional breakpoint. The condition (413) specifies the relationship between a value of an attribute of a remote execution environment and the value received from a debugger client that satisfies the condition. For example, a condition (413) of a conditional breakpoint may be implemented as the expression “processorType=‘Power5’” that specifies that the condition is satisfied if the value of the ‘processorType’ attribute of a remote execution environment is ‘Power5.’

The method of FIG. 5 includes debugging (420) a computer program in a debug session in the remote execution environment. Debugging (420) a computer program in a debug session in the remote execution environment according to the method of FIG. 5 includes retrieving (422) a stored program counter value (430). Stored program counter value (430) is the value of a computer processor's program counter when the processor encountered a conditional breakpoint. After encountering a conditional breakpoint, an interrupt handler or operating system function stores the values of the processor's hardware registers, including the current value of the program counter, in computer memory and transfers processor control to a debugger. A debugger may then retrieve the stored program counter value (430) by invoking a function of a debug API such as, for example, invoking UNIX's ‘PIOCGREG’ command through the ‘ioct1()’ function or Win32's ‘GetThreadContext’ function.

After retrieving the value of the program counter when the breakpoint was encountered, a debugger engine may then look up the breakpoint in a conditional breakpoint table like table (410), for example, to identify the condition for the conditional breakpoint. In this example, in fact, the debugger engine does not know that the breakpoint is a conditional breakpoint until the engine finds a record for the breakpoint, identified by program counter value, in table (410).

In the method of FIG. 5, debugging (420) a computer program in a debug session in the remote execution environment includes determining (423) whether a conditional breakpoint condition is satisfied. Determining (423) whether a conditional breakpoint condition is satisfied according the method of FIG. 5 may be carried out by evaluating the condition (413) associated with the conditional breakpoint in conditional breakpoints table (410). Consider, for example, a condition specified by “processorType=‘Power5’.” A debugger engine may determine (423) whether the “processorType=‘Power5’” condition is satisfied by evaluating whether the value of the ‘processorType’ attribute of the remote execution environment equals ‘Power5.’ A debugger engine may obtain the value of an attribute of the remote execution environment for determining (423) whether a breakpoint condition is satisfied by invoking a function of a Java API such as, for example, the ‘getproperties()’ function of the Java standard System class or the ‘availableprocessors()’ function of the Java standard Runtime class. In addition, operating systems typically provide configuration information regarding an execution environment through API calls available to debugger engines. Various versions of Unix provide the following functions, for example:
char *getenv(const char *name)—searches the environment list for a string the form name=value and returns a pointer to the value in the current environment.
long sysinfo(int command, char *buf, long count)—copies information relating to the operating system on which a process is executing into the buffer pointed to by buf. The count parameter indicates the size of the buffer. The POSIX P 1003.1 interface sysconf() provides a similar class of configuration information, but returns an integer rather than a string.
int uname(struct utsname *name)—stores information identifying the current operating system in the structure pointed to by name. The uname() function returns information including the name of the current operating system, the name by which the remote system is known on a communications network, the release and version numbers for the operating system, and a identification of the hardware platform and processor on which the operating system is running.
long sysconf(int name)—provides a method for a debugger to determine the current value of a configurable system limit or option (variable). The name argument represents the system variable to be queried. The following table lists the minimal set of system variables from <limits.h> and <unistd.h> that can be returned by sysconf() and the symbolic constants defined in <unistd.h> that are the corresponding values used for name.

If condition (413) is not satisfied, a debugger engine does not notify a user through a debugger client of the conditional breakpoint encounter. Rather, a debugger engine instructs the operating system to continue execution by a computer processor of the computer program under debug until encountering the next breakpoint. That is, the method of FIG. 5 continues by again to retrieving (422) a stored program counter value (430) when the processor encounters a conditional breakpoint.

If condition (413) is satisfied, the method of FIG. 5 includes retrieving (440) debug information (450) at a conditional breakpoint conditioned upon one or more attributes of the remote execution environment. Debug information (450) is a value representing the state of a computer program or a computer processor when the computer processor encountered a conditional breakpoint. Debug information (450) may include a value such as, for example, a value of a processor register, a value of a computer program variable, a value of a program counter, and so on. A debugger engine may retrieve (440) debug information (450) by invoking a function of a debug API such as, for example, invoking UNIX's ‘PIOCGREG’ command through the ‘ioctl()’ function or Win32's ‘GetThreadContext’ function. After retrieving (440) debug information (450), a debugger engine may transmits the debug information (450) to a debugger client through an endpoint of a data communications connection such as, for example, a TCP socket, for display to a user through a GUI.

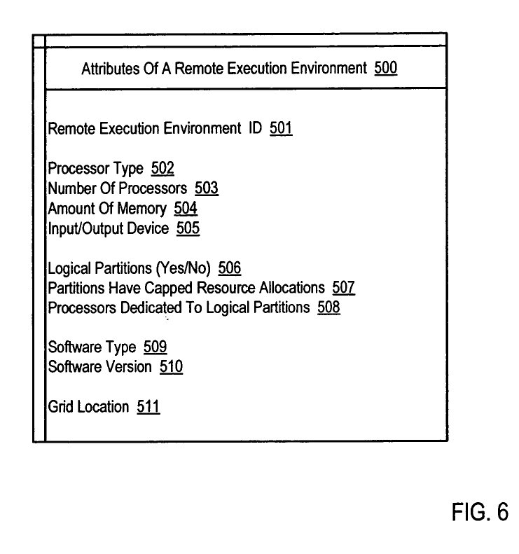

For further explanation, FIG. 6 sets forth a line drawing of an exemplary data structure that supports debugging a computer program in a distributed debugger according to embodiments of the present invention. The example data structure (500) of FIG. 6 represents attributes of a remote execution environment. Data structure (500) in the example of FIG. 6 associates a remote execution environment identifier (501) with a processor type (502), a number of processors (503), an amount of memory (504), an input/output device type (505), an indication (506) whether a remote execution environment contains logical partitions, an indication (507) whether partitions have capped resource allocations, an indication (508) whether processors are dedicated to logical partitions, a software type (509), a software version (510), and a grid location (511).

In the example of FIG. 6, data structure (500) representing attributes of the remote execution environment includes a data element (502) for representing an attribute of the remote execution environment implemented as a processor type. Data element (502) stores a value representing a type of computer processor executing computer program instructions in a remote execution environment. Data element (502) may store a value representing a computer processor type such as, for example, the IBM Power4 processor, the IBM Power5 processor, the Intel® Pentium® D processor, the AMD Athlon™ 64 processor, and so on. Readers skilled in the art will recognize that more than one data element may be needed in data structure (500) for representing a processor type if a remote execution environment contains more than one computer processor.

In the example of FIG. 6, data structure (500) representing attributes of the remote execution environment includes a data element (503) for representing an attribute of the remote execution environment implemented as a number of processors. Data element (503) stores a value representing the number of computer processor executing computer program instructions in a remote execution environment.

In the example of FIG. 6, data structure (500) representing attributes of the remote execution environment includes a data element (504) for representing an attribute of the remote execution environment implemented as an amount of memory. Data element (504) stores a value representing the amount of physical computer memory in a remote execution environment. Data element (504) may store a value representing an amount of physical computer memory in a remote execution environment such as, for example, 512 megabytes or 1 gigabyte.

In the example of FIG. 6, data structure (500) representing attributes of the remote execution environment includes a data element (505) for representing an attribute of the remote execution environment implemented as an input/output device type. Data element (505) stores a value representing a type of input/output device in a remote execution environment. Data element (505) may store a value representing a type of input/output device such as, for example, a disk drive, a key drive, a RAID storage unit, and so on. Readers skilled in the art will recognize that more than one data element may be needed in data structure (500) for representing an input/output device type if a remote execution environment contains more than one input/output device.

In the example of FIG. 6, data structure (500) representing attributes of the remote execution environment includes a data element (506) for representing an attribute of the remote execution environment implemented as an indication whether a remote execution environment contains logical partitions. Data element (506) may be implemented as a Boolean flag. A value of TRUE indicates that the remote execution environment supports logical partitions, while a value of FALSE indicates that the remote execution environment does not support logical partitions.

Exemplary data structure (500) includes a data element (507) specifying whether partitions have capped resource allocations—for use in remote execution environment that support logical partitions. Caps on resource allocations may include, for example, a maximum proportion of computer memory available to a partition, a limitation on which processor may be assigned to a particular partition, a maximum limitation on input/output capacity, and so on. Exemplary data structure (500) also includes a data element (508) specifying whether processors are dedicated to logical partitions. Exemplary data structure (500) includes a data element (509) that represents the types of computer software running in a remote execution environment. To the extent that data element (509) stores information regarding types of more than one item of software, data element (509) may be implemented as a pointer to a larger data structure where information describing types of software may be stored. Data element (509) may store data identifying types of system software such as, for example, the Linux® operating system, a Java virtual machine, a standard secure socket layer (‘SSL’), a proprietary SSL, and so on. Data element (509) also may store data identifying types of application software such as, for example, word processors, spreadsheet programs, email clients, browsers, database management systems, and so on.

Exemplary data structure (500) also includes a data element (510) the version of computer software running in a remote execution environment. Data element (510) may store the specific version or versions of system software and application software identified by data element (509) as running in the remote execution environment. To the extent that data element (510) stores information regarding the version of more than one item of software, data element (510) may be implemented as a pointer to a larger data structure where information describing versions of software may be stored. Data element (510) may store a value representing a software version such as, for example, version 1.3 of the Java Development Kit (‘JDK’), version 1.4 of the JDK, version 9 of Red Hat Linux, and so on.

Exemplary data structure (500) also includes a data element (511) representing a grid location for remote execution environments that form part of a grid computing environment. Data element (511) may store a value representing a location such as, for example, grid node identifier, geographic coordinates, a network address, and so on.

Exemplary embodiments of the present invention are described largely in the context of a fully functional computer system for debugging a computer program in a distributed debugger. Readers of skill in the art will recognize, however, that the present invention also may be embodied in a computer program product disposed on signal bearing media for use with any suitable data processing system. Such signal bearing media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets® and networks that communicate with the Internet Protocol and the World Wide Web. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method for debugging a computer program in a distributed debugger, the method comprising:
defining a conditional breakpoint conditioned upon one or more attributes of a remote execution environment;
debugging the computer program in a debug session in the remote execution environment; and
retrieving debug information at the breakpoint conditioned upon one or more attributes of the remote execution environment.

2. The method of claim 1 wherein the attributes of the remote execution environment further comprise:
indications whether processors are dedicated to logical partitions or shared across logical partitions; and
indications whether the partitions have capped or uncapped resource allocations.

3. The method of claim 1 wherein the attributes of the remote execution environment further comprise processor type, number of processors, amount of memory, and input/output device types.

4. The method of claim 1 wherein the remote execution environment further comprises a grid computing environment.

5. The method of claim 4 wherein the attributes of the remote execution environment further comprise a grid location of the remote execution environment.

6. The method of claim 1 wherein the attributes of the remote execution environment include type and version of computer software operating in the remote execution environment.

7. The method of claim 1 wherein the remote execution environment further comprises an execution environment having no graphical user interface.

8. An apparatus for debugging a computer program in a distributed debugger, the system comprising a computer processor and a computer memory operatively coupled to the computer processor, the computer memory having disposed within it computer program instructions capable of:
defining a conditional breakpoint conditioned upon one or more attributes of a remote execution environment;
debugging the computer program in a debug session in the remote execution environment; and
retrieving debug information at the breakpoint conditioned upon one or more attributes of the remote execution environment.

9. The apparatus of claim 8 wherein the attributes of the remote execution environment further comprise:
indications whether processors are dedicated to logical partitions or shared across logical partitions; and
indications whether the partitions have capped or uncapped resource allocations.

10. The apparatus of claim 8 wherein the attributes of the remote execution environment further comprise processor type, number of processors, amount of memory, and input/output device types.

11. The apparatus of claim 8 wherein the attributes of the remote execution environment include type and version of computer software operating in the remote execution environment.

12. A computer program product for debugging a computer program in a distributed debugger, the computer program product disposed upon a signal bearing medium, the computer program product comprising computer program instructions capable of:
defining a conditional breakpoint conditioned upon one or more attributes of a remote execution environment;
debugging the computer program in a debug session in the remote execution environment; and
retrieving debug information at the breakpoint conditioned upon one or more attributes of the remote execution environment.

13. The computer program product of claim 12 wherein the signal bearing medium comprises a recordable medium.

14. The computer program product of claim 12 wherein the signal bearing medium comprises a transmission medium.

15. The computer program product of claim 12 wherein the attributes of the remote execution environment further comprise:
indications whether processors are dedicated to logical partitions or shared across logical partitions; and
indications whether the partitions have capped or uncapped resource allocations.

16. The computer program product of claim 12 wherein the attributes of the remote execution environment further comprise processor type, number of processors, amount of memory, and input/output device types.

17. The computer program product of claim 12 wherein the remote execution environment further comprises a grid computing environment.

18. The computer program product of claim 17 wherein the attributes of the remote execution environment further comprise a grid location of the remote execution environment.

19. The computer program product of claim 12 wherein the attributes of the remote execution environment include type and version of computer software operating in the remote execution environment.

20. The computer program product of claim 12 wherein the remote execution environment further comprises an execution environment having no graphical user interface.
